(19) United States
(12) Patent Application Publication
(10) Pub. No.: US 2022/0156184 A1
(43) Pub. Date: May 19, 2022

(54) MEMORY SYSTEM

(71) Applicant: SK hynix Inc., Gyeonggi-do (KR)

(72) Inventors: Soon Hyun KWON, Gyeonggi-do (KR); Seok Hoon JUNG, Gyeonggi-do (KR)

(21) Appl. No.: 17/239,912

(22) Filed: Apr. 26, 2021

(30) Foreign Application Priority Data
Nov. 19, 2020 (KR) 10-2020-0155122

(51) Int. Cl. G06F 12/02; G06F 12/0831; G06F 13/16

(52) U.S. Cl. CPC G06F 12/0253; G06F 12/0238; G06F 13/1689; G06F 13/1673; G06F 12/0833

(57) ABSTRACT

A memory system includes a storage medium and a controller. The storage medium includes a plurality of memory regions. The controller delays a garbage collection operation on a memory region among the plurality of memory regions according to an invalidation ratio increase amount of the memory region.

### CROSS-REFERENCES TO RELATED APPLICATION

The present application claims priority under 35 U.S.C. § 119(a) to Korean application number 10-2020-0155122, filed on Nov. 19, 2020, which is incorporated herein by reference in its entirety as set forth in full.

### BACKGROUND

### 1. Technical Field

Various embodiments are related to a memory system, and more particularly, to a memory system including a nonvolatile memory device.

### 2. Related Art

A memory system is generally configured to store data provided by a host device in response to a write request from the host device. Furthermore, the memory system is configured to provide stored data to the host device in response to a read request from the host device. The host device is an electronic device capable of processing data and may include a computer, a digital camera or a mobile phone. The memory system to operate may be mounted in the host device or may be fabricated to be capable of being connected to and detached from the host device.

### SUMMARY

Embodiments of the present disclosure provide a memory system capable of effectively performing a garbage collection operation and an operating method thereof.

In an embodiment of the present disclosure, a memory system may include a storage medium and a controller. The storage medium may include a plurality of memory regions. The controller may be configured to delay a garbage collection operation on a memory region among the plurality of memory regions according to an invalidation ratio increase amount of the memory region.

In an embodiment of the present disclosure, a memory system may include a storage medium and a controller. The storage medium may include a plurality of memory regions. The controller may be configured to delay a garbage collection operation on a first memory region, of which an invalidation ratio increases fast among the plurality of memory regions.

In an embodiment of the present disclosure, a memory system may include a storage medium and a controller. The storage medium may include a plurality of memory regions. The controller may be configured to calculate an invalidation ratio increase amount of a memory region among the plurality of memory regions at a current update time point based on an invalidation ratio of the memory region at the current update time point and the invalidation ratio of the memory region at a previous update time point and configured to include the invalidation ratio increase amount in an invalidation ratio increase amount table. The invalidation ratio increase amount table may include invalidation ratio increase amounts of the memory region calculated respectively at one or more update time points.

An operating method of a controller, the operating method may include: measuring an invalidation ratio of a memory region whenever one or more other memory regions become closed within a memory device; performing a lower-priority garbage collection (GC) operation on a memory region when a statistical characteristic of the invalidation ratio indicates fast increase of the invalidation ratio, performing a higher-priority GC operation on the memory region when the statistical characteristic indicates slow increase of the invalidation ratio, and performing a regular-priority GC operation on the memory region when the statistical characteristic indicates regular increase of the invalidation ratio, wherein the higher-priority GC operation is performed with a higher priority than the regular-priority GC operation and the lower-priority GC operation is performed with a lower priority than the regular-priority GC operation.

According to an embodiment of the present disclosure, provided may be a memory system capable of effectively performing a garbage collection operation and an operating method thereof.

### BRIEF DESCRIPTION OF THE DRAWINGS

FIG. 1 is a block diagram illustrating a memory system according to an embodiment of the present disclosure.

FIG. 2 is a diagram illustrating an operation that a GC manager of FIG. 1 updates an invalidation ratio increase amount table according to an embodiment of the present disclosure.

FIG. 3 is a diagram illustrating an operation that a GC manager of FIG. 1 determines delay and advancement of a GC operation according to an embodiment of the present disclosure.

FIG. 4 is a diagram illustrating an operation that a GC manager of FIG. 1 determines delay and advancement of a GC operation according to an embodiment of the present disclosure.

FIG. 5 is a diagram illustrating an operation that a GC manager of FIG. 1 determines advancement of a GC operation according to an embodiment of the present disclosure.

FIG. 6 is a diagram illustrating a GC candidate list and GC delay list according to an embodiment of the present disclosure.

FIG. 7 is a flowchart illustrating an operating method of a GC manager of FIG. 1 according to an embodiment of the present disclosure.

FIG. 8 is a flowchart illustrating an operating method of a GC manager of FIG. 1 according to an embodiment of the present disclosure.

FIG. 9 is a flowchart illustrating an operating method of a GC manager of FIG. 1 according to an embodiment of the present disclosure.

FIG. 10 is a diagram illustrating a data processing system including a solid state drive (SSD) in accordance with an embodiment of the present disclosure.

FIG. 11 is a diagram illustrating a data processing system including a memory system in accordance with an embodiment of the present disclosure.

FIG. 12 is a diagram illustrating a data processing system including a memory system in accordance with an embodiment of the present disclosure.

FIG. 13 is a diagram illustrating a network system including a memory system in accordance with an embodiment of the present disclosure.

FIG. 14 is a block diagram illustrating a nonvolatile memory device included in a memory system in accordance with an embodiment of the present disclosure.

### DETAILED DESCRIPTION

Various embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The drawings are not necessarily to scale and, in some instances, proportions may have been exaggerated in order to clearly illustrate features of the embodiments. The terminology used herein is for the purpose of describing particular embodiments only and is not intended to be limiting of the invention.

As used herein, the term “and/or” includes at least one of the associated listed items. It will be understood that when an element is referred to as being “connected to”, or “coupled to” another element, it may be directly on, connected to, or coupled to the other element, or one or more intervening elements may be present. As used herein, singular forms are intended to include the plural forms and vice versa, unless the context clearly indicates otherwise. It will be further understood that the terms “comprises,” “comprising,” “includes,” and “including” when used in this specification, specify the presence of the stated elements and do not preclude the presence or addition of one or more other elements.

Hereinafter, various embodiments of the present disclosure will be described below with reference to the accompanying drawings.

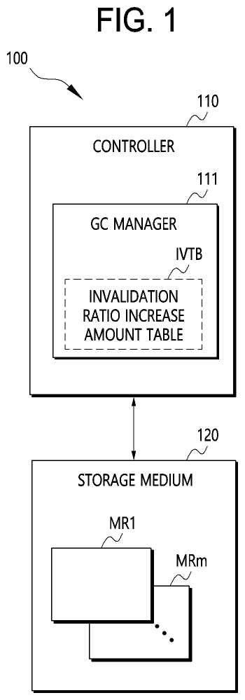

FIG. 1 is a block diagram illustrating a memory system 100 according to an embodiment of the present disclosure.

The memory system 100 may be configured to store data, which is provided from an external host device, in response to a write request from the host device. The memory system 100 may be configured to provide a host device with data, which is stored therein, in response to a read request from the host device.

The memory system 100 may be configured as a personal computer memory card international association (PCMCIA) card, a compact flash (CF) card, a smart media card, a memory stick, various multimedia cards (e.g., MMC, eMMC, RS-MMC, and MMC-micro), secure digital (SD) cards (e.g., SD, Mini-SD and Micro-SD), a universal flash storage (UFS) or a solid state drive (SSD).

The memory system 100 may include a controller 110 and a storage medium 120.

The controller 110 may control an overall operation of the memory system 100. The controller 110 may control the storage medium 120 in order to perform a foreground operation in response to an instruction from a host device. The foreground operation may include operations of writing data in the storage medium 120 and reading data from the storage medium 120 in response to instructions from a host device, that is, a write request and a read request.

Furthermore, the controller 110 may control the storage medium 120 in order to perform an internally necessary background operation independently of a host device. The background operation may include at least one among a wear-leveling operation, a garbage collection operation (hereinafter, referred to as a ‘GC operation’), an erase operation, a read reclaim operation, and a refresh operation for the storage medium 120. Like the foreground operation, the background operation may include operations of writing data in the storage medium 120 and reading data from the storage medium 120.

The controller 110 may include a GC manager 111.

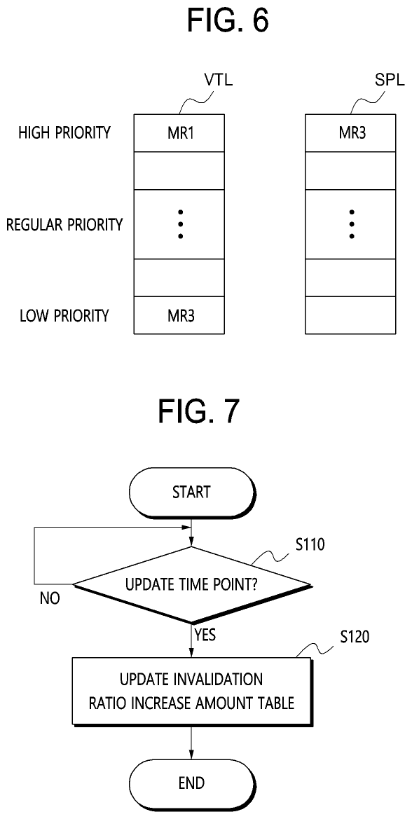

The GC manager 111 may delay a GC operation on a memory region, of which an invalidation ratio increases fast, compared with other memory regions of which an invalidation ratio varies within a regular range, and thus on which a regular GC operation of a regular priority is performed. That is, the GC manager 111 may perform a GC operation on the memory region of the fast-increasing invalidation ratio with a lower priority than other memory regions. The GC operation of a lower priority may be performed later than the regular GC operation in an order of the GC operations to be performed on memory regions. The GC manager 111 may advance a GC operation on a memory region, of which an invalidation ratio increases slowly, compared with other memory regions of which the invalidation ratio varies within the regular range, and thus on which the regular GC operation is to be performed. That is, the GC manager 111 may perform a GC operation on the memory region of the slow-increasing invalidation ratio with a higher priority than other memory regions. The GC operation of a higher priority may be performed earlier than the regular GC operation in the order of the GC operations to be performed on memory regions. The order of the GC operation to be performed on memory regions will be described in detail with reference to FIG. 6. According to an embodiment, the GC manager 111 may further predict a possibility of operational performance degradation of the memory system 100 to advance a GC operation on a memory region, of which an invalidation ratio increases slowly, compared with other memory regions.

In order to determine an increasing rate of an invalidation ratio, the GC manager 111 may manage an invalidation ratio increase amount table IVTB. The invalidation ratio increase amount table IVTB may include invalidation ratio increase amounts at one or more update time points for each memory region.

For each memory region, the GC manager 111 may calculate, as an invalidation ratio increase amount at a current update time point, a difference between an invalidation ratio at the current update time point and an invalidation ratio at a previous update time point. The GC manager 111 may add the calculated invalidation ratio increase amount into the invalidation ratio increase amount table IVTB.

By referring to the updated invalidation ratio increase amount table IVTB, the GC manager 111 may determine that an invalidation ratio of a memory region increases fast and may delay a GC operation on the memory region when an average of one or more invalidation ratio increase amounts of the memory region is determined as greater than a first threshold (hereinafter, referred to as a ‘delay threshold’). Here, the one or more invalidation ratio increase amounts may be selected by a predetermined number from the invalidation ratio increase amount at the current update time point. The average of one invalidation ratio increase amount may be the one invalidation ratio increase amount itself.

By referring to the updated invalidation ratio increase amount table IVTB, the GC manager 111 may determine that an invalidation ratio of a memory region increases slowly and may advance a GC operation on the memory region when an average of one or more invalidation ratio increase amounts of the memory region is determined to be less than a second threshold (hereinafter, referred to as a ‘advancement threshold’). According to an embodiment, the GC manager 111 may advance a GC operation on a memory region, of which the invalidation ratio increases slowly, when an operational performance of the memory system 100 is predicted not to be degraded even if a GC operation is performed on the memory region.

According to an embodiment, the GC manager 111 may determine the delay/advancement of GC operations on memory regions, which are utilized as single level cell (SLC) buffers among memory regions MR1 to MRm, through the invalidation ratio increase amount table IVTB according to the above described scheme.

To sum up, when the invalidation of a memory region is naturally ongoing fast due to the locality, a GC operation may not be necessarily required to be performed on the memory region. Therefore, the GC manager 111 may delay the GC operation on the memory region, of which the invalidation ratio increases fast, thereby suppressing an unnecessary GC operation.

When an invalidation of a memory region progresses slowly, cold data may be stored in the memory region. Therefore, the GC manager 111 may advance a GC operation on the memory region instead of performing a wear levelling operation on the memory region, thereby reducing a burden to be later laid on the memory system 100. In this case, the GC operation may keep the data reliability by refreshing the cold data. When advancing the GC operations on the SLC buffers, available storage spaces of the SLC buffers may be constantly secured, which may excellently improve the response performance to a host device.

According to an embodiment, the controller 110 may operate based on a validation ratio decrease amount table instead of the invalidation ratio increase amount table IVTB. In this case, the validation ratio decrease amount table may include validation ratio decrease amounts of each memory region. For each memory region, a validation ratio decrease amount at a current update time point may be calculated on the basis of a difference between a validation ratio at the current update time point and a validation ratio at a previous update time point. Therefore, by referring to the validation ratio decrease amount table, the controller 110 may delay a GC operation on a memory region, of which a validation ratio decreases fast, and may advance a GC operation on a memory region, of which a validation ratio decreases slowly. That is, the invalidation ratio and the validation ratio of a memory region may have a complement relationship and therefore the utilization of any of the invalidation ratio and the validation ratio may be applied to an embodiment of the present disclosure.

The storage medium 120 may store therein, under the control of the controller 110, data provided from a host device.

The controller 110 may configure the plurality of memory regions MR1 to MRm within the storage medium 120. Each memory region may include a plurality of memory blocks. An erase operation may be performed by units of memory blocks within the storage medium 120. Each memory block may include a plurality of memory units. A write operation or a read operation may be performed by units of memory units within the storage medium 120.

Under the control of the controller 110, the storage medium 120 may access, in parallel, memory blocks configuring a single memory region. Such a parallel access scheme may increase an amount of data that is written into or read from the storage medium 120 at a time thereby improving the performance of the memory system 100.

The memory regions MR1 to MRm may include an empty memory region and a memory region, in which data is at least partly stored. When an empty memory region is selected to store data therein, it may be expressed that the memory region is open. That is, an open memory region may be a memory region, in which data is being stored. When an open memory region becomes full of data, it may be expressed that the memory region is closed. That is, a closed memory region may be a memory region, in which any further data cannot be stored.

Data stored in a memory region gradually becomes invalidated. When a ratio of invalidated data (hereinafter, referred to as the ‘invalidation ratio’) increases in a memory region, a GC operation may be performed on the memory region to secure an available storage space. Through the GC operation, valid data stored in a victim memory region may be moved to another memory region and the victim memory region may become an empty memory region by an erase operation.

A part of the memory regions MR1 to MRm may be utilized as SLC buffers. For example, remaining memory regions other than the SLC buffers among the memory regions MR1 to MRm may be triple level cell (TLC) memory regions each having greater storage space than the SLC buffer. Data may be stored preferentially into the SLC buffer and then moved from the SLC buffer to the TLC memory region.

The memory blocks configuring a single memory region may be disposed within one or more non-volatile memory apparatuses. The non-volatile memory apparatus may include a flash memory device (e.g., the NAND Flash or the NOR Flash), the Ferroelectrics Random Access Memory (FeRAM), the Phase-Change Random Access Memory (PCRAM), the Magnetic Random Access Memory (MRAM), the Resistive Random Access Memory (ReRAM) and so forth. The non-volatile memory apparatus may include one or more planes, one or more memory chips, one or more memory dies or one or more memory packages.

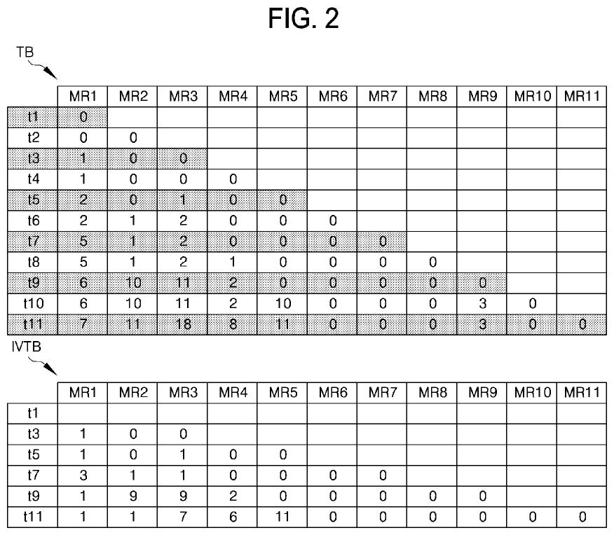

FIG. 2 is a diagram illustrating an operation that the GC manager 111 of FIG. 1 updates the invalidation ratio increase amount table IVTB according to an embodiment of the present disclosure.

Referring to FIG. 2, in an invalidation ratio table TB, time points t1 to t11 may mean when the memory regions MR1 to MRm become sequentially closed. Entry values within the invalidation ratio table TB may be invalidation ratios of memory regions in use among the memory regions MR1 to MRm at each of the time points t1 to t11. For example, the invalidation ratio may be expressed as a percentage. At each of the time points t1 to t11, the GC manager 111 may calculate the invalidation ratio of each memory region by referring to information on whether data stored in the corresponding memory region is valid or invalid.

For example, the memory region MR1 may become closed and the memory regions MR2 to MR11 may remain empty at the time point t1. The invalidation ratio of the memory region MR1 may be “0” at the time point t1. When the memory region MR2 becomes closed at the time point t2, each of the invalidation ratios of the memory regions MR1 and MR2 may be “0”. When the memory region MR3 becomes closed at the time point t3, the invalidation ratio of the memory region MR1 may be “1” and each of the invalidation ratios of the memory regions MR2 and MR3 may be “0”.

The invalidation ratio increase amount table IVTB may include the invalidation ratio increase amounts of the respective memory regions MR1 to MRm calculated on the basis of the invalidation ratios of the respective memory regions MR1 to MRm. For each of the memory regions MR1 to MRm, the invalidation ratio increase amount at a current time point may be calculated on the basis of a difference between the invalidation ratio at the current time point and the invalidation ratio at a previous time point, which is prior to the current time point.

According to an embodiment, the invalidation ratio increase amount table IVTB may be updated whenever “n” number of memory regions become closed. Once updated, the invalidation ratio increase amount table IVTB may be updated again when “n” number of memory regions become closed. For example, when “n” is “2”, the invalidation ratio increase amount table IVTB may be updated at the time points t1, t3, t5, t7, t9 and t11.

Specifically, the invalidation ratio increase amount table IVTB may include an initial value, e.g., “0” at the update time point t1. The GC manager 111 may initialize the invalidation ratio increase amount table IVTB at the update time point t1.

At the update time point t3, the GC manager 111 may calculate the invalidation ratio increase amounts from the update time point t1 to the update time point t3 for the respective memory regions MR1 to MR3. For example, the invalidation ratio increase amount of the memory region MR1 may be “1”. Since each of the memory regions MR2 and MR3 is empty at the time point t1, the invalidation ratio of each of the memory regions MR2 and MR3 may be regarded as “0” at the time point t1 and the invalidation ratio increase amount from the update time point t1 to the update time point t3 for each of the memory regions MR2 and MR3 may be calculated as “0”.

At the update time point t5, the GC manager 111 may calculate the invalidation ratio increase amounts from the update time point t3 to the update time point t5 for the respective memory regions MR1 to MR5. For example, the invalidation ratio increase amount from the update time point t3 to the update time point t5 for each of the memory regions MR1 and MR3 may be “1”. The invalidation ratio increase amount from the update time point t3 to the update time point t5 for each of the memory regions MR2, MR4 and MR5 may be “0”. In the similar manner, the GC manager 111 may calculate the invalidation ratio increase amounts from the previous time point to the current update time point for the respective memory regions in use at each of the update time points t7, t9 and t11.

According to an embodiment, the GC manager 111 may calculate the invalidation ratio of each of the memory regions MR1 to MRm only at the update time points t1, t3, t5, t7, t9 and t11 instead of calculating the invalidation ratio of each of the memory regions MR1 to MRm at all the time points t1 to t11 of the invalidation ratio table TB. In this case, the GC manager 111 may calculate the invalidation ratio increase amount of each of the memory regions MR1 to MRm at the current update time point based on the invalidation ratio at the previous update time point and the invalidation ratio at the current update time point and therefore the GC manager 111 may calculate only the invalidation ratios required for the calculation of the invalidation ratio increase amount. The GC manager 111 may manage, as the invalidation ratio table TB or another data structure, only the invalidation ratios required for the calculation of the invalidation ratio increase amount at the current update time point.

According to an embodiment, the update time points of the invalidation ratio increase amount table IVTB may include when the memory system 100 enters an idle state.

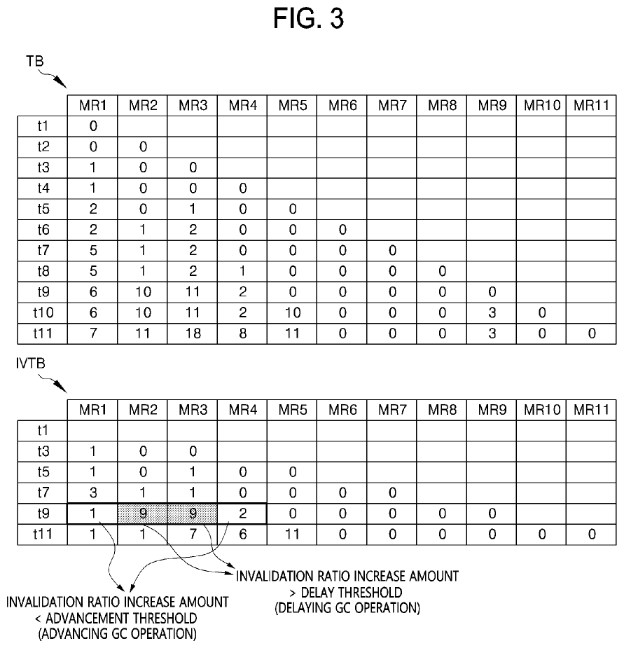

FIG. 3 is a diagram illustrating an operation that the GC manager 111 of FIG. 1 determines delay and advancement of a GC operation according to an embodiment of the present disclosure.

Referring to FIG. 3, the GC manager 111 may determine an increase rate of the invalidation ratio of each of the memory regions MR1 to MR11 by referring to the invalidation ratio increase amount table IVTB. In this disclosure, an invalidation ratio that substantially stays at a certain value may also be regarded as an invalidation ratio that slowly increases.

Specifically, the GC manager 111 may determine an invalidation ratio of a memory region as increasing fast when an invalidation ratio increase amount of the memory region is determined as greater than the delay threshold by referring to the invalidation ratio increase amount table IVTB. On the other hand, the GC manager 111 may determine an invalidation ratio of a memory region as increasing slowly when an invalidation ratio increase amount of the memory region is determined as less than the advancement threshold by referring to the invalidation ratio increase amount table IVTB.

According to an embodiment, the delay threshold may be different from the advancement threshold and may be greater than the advancement threshold. According to an embodiment, the delay threshold may be the same as the advancement threshold.

The GC manager 111 may determine to delay a GC operation on the memory region, of which the invalidation ratio is determined as increasing fast. The GC manager 111 may determine to advance a GC operation on the memory region, of which the invalidation ratio is determined as increasing slowly.

For example, at the time point t9, the GC manager 111 may determine an invalidation ratio increase amount “9” of each of the memory regions MR2 and MR3 as greater than the delay threshold by referring to the invalidation ratio increase amount table IVTB and may determine an invalidation ratio of each of the memory regions MR2 and MR3 as increasing fast. Therefore, the GC manager 111 may determine to delay a GC operation on each of the memory regions MR2 and MR3.

On the other hand, at the time point t9, the GC manager 111 may determine each of invalidation ratio increase amounts “1” of the memory region MR1 and “2” of the memory region MR4 as less than the advancement threshold by referring to the invalidation ratio increase amount table IVTB and may determine an invalidation ratio of each of the memory regions MR1 and MR4 as increasing slowly. Therefore, the GC manager 111 may determine to advance a GC operation on each of the memory regions MR1 and MR4.

Although further description will be omitted, the determination of whether to delay/advance the GC operation on each of remaining ones among the memory regions MR1 to MR11 may be made in the similar manner.

When an invalidation ratio increase amount of a memory region is determined as not greater than the delay threshold and not less than the advancement threshold, that is, when the invalidation ratio increase amount of the memory region is determined to belong to the regular range, the GC manager 111 may determine not to delay or advance a GC operation on the memory region, that is, the GC manager 111 may determine to perform the regular GC operation on the memory region.

According to an embodiment, the GC manager 111 may determine to delay or advance a GC operation on a memory region a predetermined amount of time after the memory region becomes closed.

According to an embodiment, the GC manager 111 may determine to delay or advance a GC operation on a memory region when a number of empty memory regions or an available storage capacity becomes less than a predetermined threshold within the storage medium 120.

According to an embodiment, once the determination of whether to delay/advance a GC operation on a memory region is made at a certain time point, the manager 111 may determine again to delay or advance the GC operation on the memory region at a different time point.

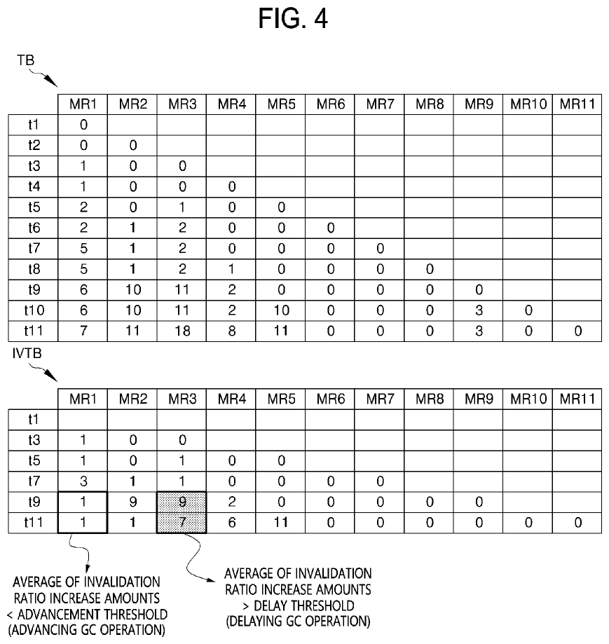

FIG. 4 is a diagram illustrating an operation that the GC manager 111 of FIG. 1 determines delay and advancement of a GC operation according to an embodiment of the present disclosure.

Referring to FIG. 4, according to an embodiment, the GC manager 111 may refer to an average of the invalidation ratio increase amounts of a plurality of time points rather than referring to the invalidation ratio increase amount of a single time point as described with reference to FIG. 3.

Specifically, the GC manager 111 may determine an invalidation ratio of a memory region as increasing fast when an average of a predetermined number of consecutive invalidation ratio increase amounts of the memory region is determined as greater than the delay threshold by referring to the invalidation ratio increase amount table IVTB. On the other hand, the GC manager 111 may determine an invalidation ratio of a memory region as increasing slowly when an average of a predetermined number of consecutive invalidation ratio increase amounts of the memory region is determined as less than the advancement threshold by referring to the invalidation ratio increase amount table IVTB. For example, the GC manager 111 may refer to an average of 2 consecutive invalidation ratio increase amounts as follows.

For example, at the time point t11, the GC manager 111 may determine an average “8” of the invalidation ratio increase amounts “9” and “7” of the memory region MR3 at the time points t9 and t11 as greater than the delay threshold by referring to the invalidation ratio increase amount table IVTB and may determine an invalidation ratio of the memory region MR3 as increasing fast. Therefore, the GC manager 111 may determine to delay a GC operation on the memory region MR3. However, at the time point t11, the GC manager 111 may determine an average “5” of the invalidation ratio increase amounts “9” and “1” of the memory region MR2 at the time points t9 and t11 as not greater than the delay threshold by referring to the invalidation ratio increase amount table IVTB. Therefore, the GC manager 111 may determine not to delay a GC operation on the memory region MR2, which is different from the case of FIG. 3.

On the other hand, at the time point t11, the GC manager 111 may determine an average “1” of the invalidation ratio increase amounts “1” and “1” of the memory region MR1 at the time points t9 and t11 as less than the advancement threshold by referring to the invalidation ratio increase amount table IVTB and may determine an invalidation ratio of the memory region MR1 as increasing slowly. Therefore, the GC manager 111 may determine to advance a GC operation on the memory region MR1. However, at the time point t11, the GC manager 111 may determine an average “4” of the invalidation ratio increase amounts “2” and “6” of the memory region MR4 at the time points t9 and t11 as not less than the advancement threshold by referring to the invalidation ratio increase amount table IVTB. Therefore, the GC manager 111 may determine not to advance a GC operation on the memory region MR4, which is different from the case of FIG. 3.

To sum up, the GC operation may be performed according to the tendency of the invalidation ratio, rather than the temporary fluctuation thereof, by considering an average of the plurality of invalidation ratio increase amounts. Therefore, the user workload may be reflected more precisely into the GC operation, which makes it possible to perform an optimized GC operation.

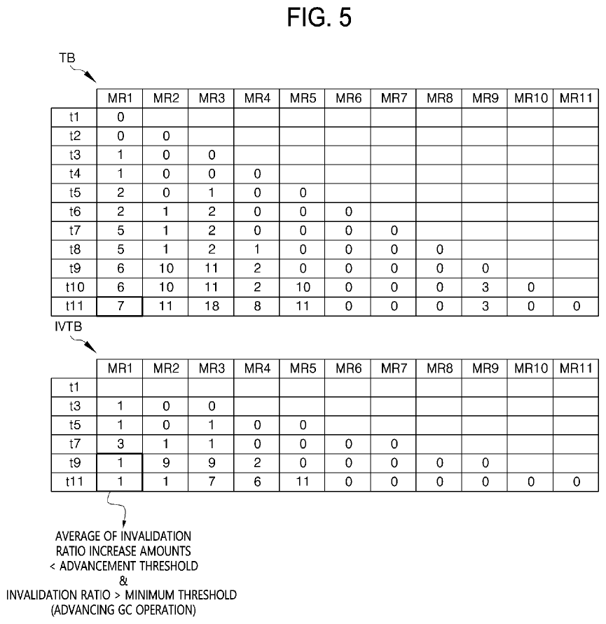

FIG. 5 is a diagram illustrating an operation that the GC manager 111 of FIG. 1 determines advancement of a GC operation according to an embodiment of the present disclosure.

Referring to FIG. 5, according to an embodiment, the GC manager 111 may further determine whether an additional condition is satisfied on a memory region, of which the invalidation ratio is determined as increasing slowly. The additional condition on the memory region may be that the operational performance of the memory system 100 should not be degraded even if the GC operation is performed on the memory region. For example, the additional condition on the memory region may be that the invalidation ratio of the memory region should be greater than a third threshold (hereinafter, referred to as a ‘minimum threshold’).

Therefore, when further considering the additional condition on a memory region, the GC manager 111 may determine to advance a GC operation on the memory region when an average of one or more invalidation ratio increase amounts of the memory region is determined as less than the advancement threshold and the invalidation ratio of the memory region is determined as greater than the minimum threshold. On the other hand, the GC manager 111 may determine not to advance a GC operation on the memory region when an average of one or more invalidation ratio increase amounts of the memory region is determined as less than the advancement threshold but the invalidation ratio of the memory region is determined as not greater than the minimum threshold.

For example, at the time point t11, the GC manager 111 may determine the average “1” of the invalidation ratio increase amounts of the memory region MR1 at the time points t9 and t11 as less than the advancement threshold and may determine an invalidation ratio “7” of the memory region MR1 at the time point t11 as greater than the minimum threshold. Therefore, the GC manager 111 may determine to advance a GC operation on the memory region MR1.

According to an embodiment, the additional condition on a memory region may be that a ratio of a transmission amount of data due to a GC operation on the memory region to a transmission amount of data due to requests of a host device should be less than a predetermined ratio. In order to determine whether such additional condition is satisfied on the memory region, the GC manager 111 may predict an amount of data to be processed between the controller 110 and the storage medium 120 due to currently pending requests of a host device. The GC manager 111 may determine such an additional condition as satisfied on the memory region when the predicted amount of data is less than the predetermined value.

FIG. 6 is a diagram illustrating a GC candidate list VTL and GC delay list SPL according to an embodiment of the present disclosure.

Referring to FIG. 6, the GC candidate list VTL may include one or more memory regions, on which GC operations are expected to be performed among the memory regions MR1 to MRm included in the storage medium 120. For example, the GC candidate list VTL may include a memory region, of which the invalidation ratio is greater than a predetermined GC threshold, which will not limit the present disclosure. The GC manager 111 may sequentially perform the GC operation according to the priority order in the GC candidate list VTL. When performing a GC operation, the GC manager 111 may perform the GC operation first on a memory region of a highest priority within the GC candidate list VTL.

By managing the GC candidate list VTL, the GC manager 111 may delay the GC operation on the memory region MR3 according to the determination as described with reference to FIG. 4. Specifically, when the memory region MR3 is included in the GC candidate list VTL, the GC manager 111 may lower the priority of the memory region MR3 as much as predetermined ranks within the GC candidate list VTL. For example, the memory region MR3 may be ranked on bottom of the GC candidate list VTL. According to an embodiment, when the memory region MR3 is included in the GC candidate list VTL, the GC manager 111 may evict the memory region MR3 from the GC candidate list VTL. When the memory region MR3 is evicted from the GC candidate list VTL, the GC operation may not be performed on the memory region MR3.

By managing the GC candidate list VTL, the GC manager 111 may advance the GC operation on the memory region MR1 according to the determination as described with reference to FIG. 4. Specifically, when the memory region MR1 is not yet included in the GC candidate list VTL, the GC manager 111 may include the memory region MR1 into the GC candidate list VTL and may assign a high priority to the memory region MR1. For example, the memory region MR1 may be ranked on top of the GC candidate list VTL. According to an embodiment, when the memory region MR1 is included in the GC candidate list VTL, the GC manager 111 may raise the priority of the memory region MR1 as much as predetermined ranks within the GC candidate list VTL.

In order to delay the GC operation on the memory region MR3, the GC manager 111 may further manage the GC delay list SPL. Specifically, when the memory region MR3 is not included in the GC delay list SPL, the GC manager 111 may include the memory region MR3 into the GC delay list SPL. As shown in FIG. 6, the memory region MR3 may be added to the GC delay list SPL while being present in the GC candidate list VTL. According to an embodiment, the memory region MR3 may be evicted from the GC candidate list VTL and added only to the GC delay list SPL. Even when a condition to include the memory region MR3 into the GC candidate list VTL (e.g., a condition that the invalidation ratio of the memory region MR3 should be greater than the GC threshold) is satisfied, the GC manager 111 may not include the memory region MR3 into the GC candidate list VTL as long as the memory region MR3 is included in the GC delay list SPL.

According to an embodiment, the GC manager 111 may evict the memory region MR3 from the GC delay list SPL when determining to advance a GC operation on the memory region MR3. According to an embodiment, the GC manager 111 may evict the memory region MR3 from the GC delay list SPL a predetermined amount of time after the memory region MR3 is included in the GC delay list SPL. According to an embodiment, the GC manager 111 may evict the memory region MR3 from the GC delay list SPL when all data stored in the memory region MR3 becomes invalidated.

FIG. 7 is a flowchart illustrating an operating method of the GC manager 111 of FIG. 1 according to an embodiment of the present disclosure.

Referring to FIG. 7, in operation S110, the GC manager 111 may determine whether it is an update time point to update the invalidation ratio increase amount table IVTB. For example, the GC manager 111 may determine whether “n” number of memory regions become closed after the latest update time point. For example, the GC manager 111 may determine whether the memory system 100 enters the idle state. When it is not determined that it is the update time point, the process may repeat operation S110. When it is determined that it is the update time point, the process may proceed to operation S120.

In operation S120, the GC manager 111 may update the invalidation ratio increase amount table IVTB. For example, for each memory region, the GC manager 111 may calculate, as the invalidation ratio increase amount, the difference between the invalidation ratio of the previous update time point and the invalidation ratio of the current update time point and may include the calculated invalidation ratio increase amount into the invalidation ratio increase amount table IVTB.

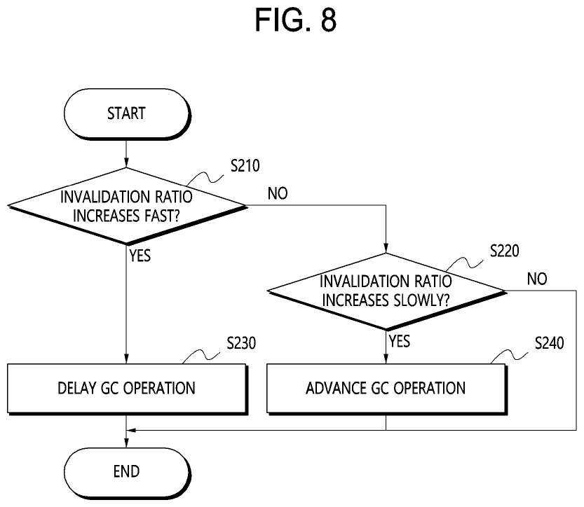

FIG. 8 is a flowchart illustrating an operating method of the GC manager 111 of FIG. 1 according to an embodiment of the present disclosure.

Referring to FIG. 8, in operation S210, the GC manager 111 may determine whether the invalidation ratio of a memory region increases fast by referring to the updated invalidation ratio increase amount table IVTB. For example, when an average of one or more invalidation ratio increase amounts of the memory region is determined as greater than the delay threshold, the GC manager 111 may determine that the invalidation ratio of the memory region increases fast. When the invalidation ratio of the memory region is determined as not increasing fast, the process may proceed to operation S220. When the invalidation ratio of the memory region is determined as increasing fast, the process may proceed to operation S230.

In operation S220, the GC manager 111 may determine whether the invalidation ratio of the memory region increases slowly by referring to the updated invalidation ratio increase amount table IVTB. For example, when an average of one or more invalidation ratio increase amounts of the memory region is determined as less than the advancement threshold, the GC manager 111 may determine that the invalidation ratio of the memory region increases slowly. When the invalidation ratio of the memory region is determined as not increasing slowly, the process may end. When the invalidation ratio of the memory region is determined as increasing slowly, the process may proceed to operation S240.

In operation S230, the GC manager 111 may delay a GC operation on the memory region.

In operation S240, the GC manager 111 may advance a GC operation on the memory region.

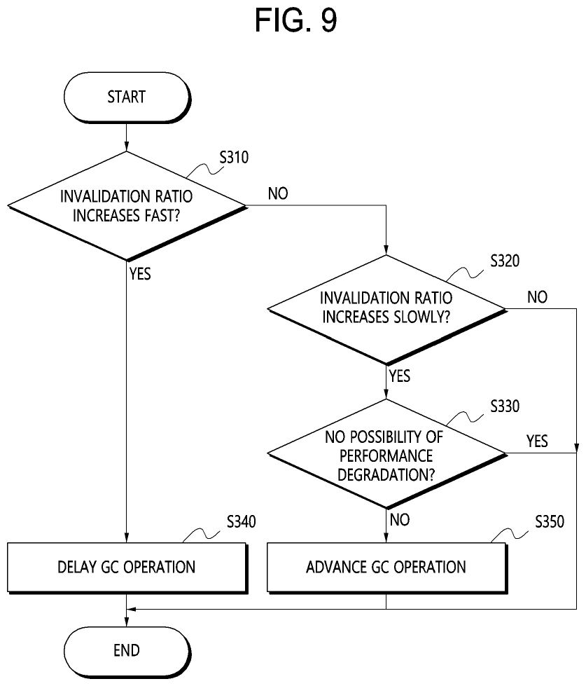

FIG. 9 is a flowchart illustrating an operating method of the GC manager 111 of FIG. 1 according to an embodiment of the present disclosure.

Referring to FIG. 8, in operation S310, the GC manager 111 may determine whether the invalidation ratio of a memory region increases fast by referring to the updated invalidation ratio increase amount table IVTB. When the invalidation ratio of the memory region is determined as not increasing fast, the process may proceed to operation S320. When the invalidation ratio of the memory region is determined as increasing fast, the process may proceed to operation S340.

In operation S320, the GC manager 111 may determine whether the invalidation ratio of the memory region increases slowly by referring to the updated invalidation ratio increase amount table IVTB. When the invalidation ratio of the memory region is determined as not increasing slowly, the process may end. When the invalidation ratio of the memory region is determined as increasing slowly, the process may proceed to operation S330.

In operation S330, the GC manager 111 may predict whether the operational performance of the memory system 100 is not to be degraded even if the GC operation is performed on the memory region. For example, the GC manager 111 may predict the operational performance will not be degraded when the invalidation ratio of the memory region is determined as greater than the minimum threshold. When the operational performance is predicted to be degraded, the process may end. When the operational performance is predicted not to be degraded, the process may proceed to operation S350.

In operation S340, the GC manager 111 may delay a GC operation on the memory region.

In operation S350, the GC manager 111 may advance a GC operation on the memory region.

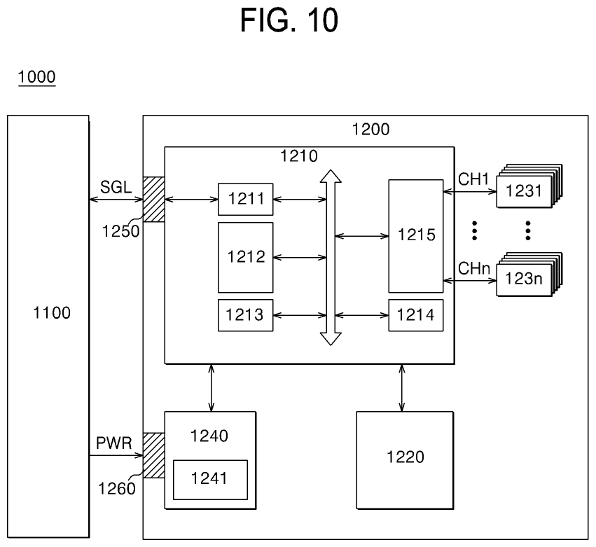

FIG. 10 is a diagram illustrating a data processing system 1000 including a solid state drive (SSD) 1200 in accordance with an embodiment of the present disclosure. Referring to FIG. 10, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may include a host interface unit 1211, a control unit 1212, a random access memory 1213, an error correction code (ECC) unit 1214, and a memory interface unit 1215.

The host interface unit 1211 may exchange a signal SGL with the host device 1100 through the signal connector 1250. The signal SGL may include a command, an address, data, and so forth. The host interface unit 1211 may interface the host device 1100 and the SSD 1200 according to the protocol of the host device 1100. For example, the host interface unit 1211 may communicate with the host device 1100 through any of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnect (PCI), PCI express (PCI-E) and universal flash storage (UFS).

The control unit 1212 may analyze and process the signal SGL received from the host device 1100. The control unit 1212 may control operations of internal function blocks according to a firmware or a software for driving the SSD 1200. The control unit 1212 may include the GC manager 111 shown in FIG. 1. The random access memory 1213 may be used as a working memory for driving such a firmware or software.

The ECC unit 1214 may generate the parity data of data to be transmitted to at least one of the nonvolatile memory devices 1231 to 123n. The generated parity data may be stored together with the data in the nonvolatile memory devices 1231 to 123n. The ECC unit 1214 may detect an error of the data read from at least one of the nonvolatile memory devices 1231 to 123n, based on the parity data. If a detected error is within a correctable range, the ECC unit 1214 may correct the detected error.

The memory interface unit 1215 may provide control signals such as commands and addresses to at least one of the nonvolatile memory devices 1231 to 123n, according to control of the control unit 1212. Moreover, the memory interface unit 1215 may exchange data with at least one of the nonvolatile memory devices 1231 to 123n, according to control of the control unit 1212. For example, the memory interface unit 1215 may provide the data stored in the buffer memory device 1220, to at least one of the nonvolatile memory devices 1231 to 123n, or provide the data read from at least one of the nonvolatile memory devices 1231 to 123n, to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured by various types of connectors depending on an interface scheme between the host device 1100 and the SSD 1200.

The power connector 1260 may be configured by various types of connectors depending on a power supply scheme of the host device 1100.

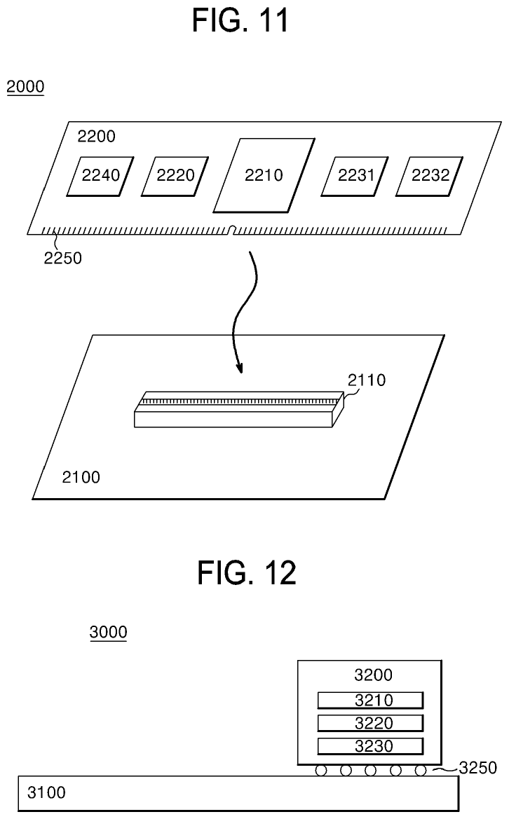

FIG. 11 is a diagram illustrating a data processing system 2000 including a memory system 2200 in accordance with an embodiment of the present disclosure. Referring to FIG. 11, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 10.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth, and power may be transferred between the host device 2100 and the memory system 2200. The connection terminal 2250 may be configured into various types depending on an interface scheme between the host device 2100 and the memory system 2200. The connection terminal 2250 may be disposed on any side of the memory system 2200.

FIG. 12 is a diagram illustrating a data processing system 3000 including a memory system 3200 in accordance with an embodiment of the present disclosure. Referring to FIG. 12, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 10.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

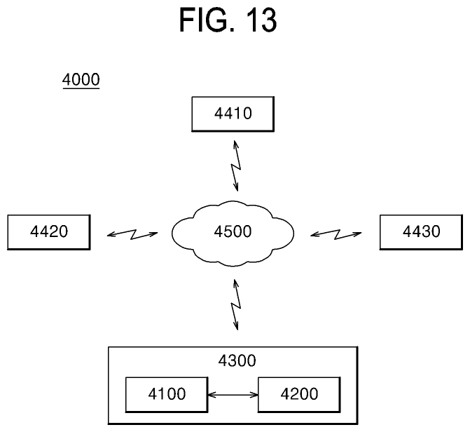

FIG. 13 is a diagram illustrating a network system 4000 including a memory system 4200 in accordance with an embodiment of the present disclosure. Referring to FIG. 13, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 shown in FIG. 1, the memory system 1200 shown in FIG. 10, the memory system 2200 shown in FIG. 11 or the memory system 3200 shown in FIG. 12.

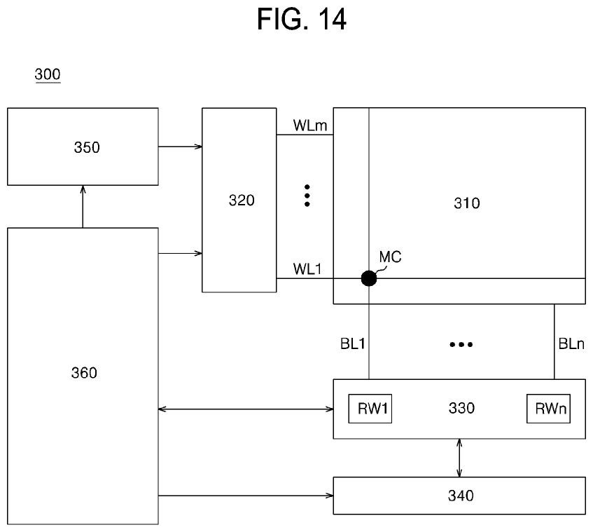

FIG. 14 is a block diagram illustrating a nonvolatile memory device 300 included in a memory system in accordance with an embodiment of the present disclosure. Referring to FIG. 14, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

While certain embodiments have been described above, it will be understood to those skilled in the art that the embodiments described are by way of example only. Accordingly, the memory system should not be limited based on the described embodiments. Rather, the memory system described herein should only be limited in light of the claims that follow when taken in conjunction with the above description and accompanying drawings.

What is claimed is:

1. A memory system comprising:
a storage medium including a plurality of memory regions; and
a controller configured to delay a garbage collection operation on a memory region among the plurality of memory regions according to an invalidation ratio increase amount of the memory region.

2. The memory system of claim 1, wherein the controller is further configured to calculate, as the invalidation ratio increase amount at a current update time point, a difference between an invalidation ratio of the memory region at the current update time point and the invalidation ratio of the memory region at a previous update time point.

3. The memory system of claim 2, wherein the controller delays the garbage collection operation when an average of invalidation ratio increase amounts of the memory region at one or more update time points is determined to be greater than a delay threshold.

4. The memory system of claim 2, wherein the controller is further configured to advance the garbage collection operation when an average of invalidation ratio increase amounts of the memory region at one or more update time points is determined to be less than an advancement threshold.

5. The memory system of claim 2, wherein the controller is further configured to advance the garbage collection operation when an average of invalidation ratio increase amounts of the memory region at one or more update time points is determined to be less than an advancement threshold and an invalidation ratio of the memory region is determined to be greater than a minimum threshold.

6. The memory system of claim 1, wherein the controller delays the garbage collection operation by updating at least one of a garbage collection candidate list and a garbage collection delay list.

7. The memory system of claim 1, wherein the memory region is a single level cell (SLC) buffer.

8. A memory system comprising:
a storage medium including a plurality of memory regions; and
a controller configured to delay a garbage collection operation on a first memory region, of which an invalidation ratio increases fast among the plurality of memory regions.

9. The memory system of claim 8, wherein the controller delays the garbage collection operation on the first memory region by lowering a priority of the first memory region within a garbage collection candidate list.

10. The memory system of claim 8, wherein the controller evicts the first memory region from a garbage collection candidate list.

11. The memory system of claim 8, wherein the controller is further configured to include the first memory region in a garbage collection delay list and configured not to include the first memory region in a garbage collection candidate list as long as the first memory region is included in the garbage collection delay list.

12. The memory system of claim 8, wherein the controller is further configured to advance the garbage collection operation on a second memory region, of which the invalidation ratio increases slowly among the plurality of memory regions.

13. The memory system of claim 12, wherein the controller advances the garbage collection operation on the second memory region by including the second memory region in a garbage collection candidate list and assigning a high priority to the second memory region.

14. The memory system of claim 13, wherein the controller evicts, when the second memory region is included in a garbage collection delay list, the second memory region from the garbage collection delay list.

15. The memory system of claim 12, wherein the controller advances the garbage collection operation on the second memory region when it is determined that there is not a possibility of degradation of an operational performance of the memory system due to the garbage collection operation on the second memory region.

16. A memory system comprising:
a storage medium including a plurality of memory regions; and
a controller configured to calculate an invalidation ratio increase amount of a memory region among the plurality of memory regions at a current update time point based on an invalidation ratio of the memory region at the current update time point and the invalidation ratio of the memory region at a previous update time point and configured to include the invalidation ratio increase amount in an invalidation ratio increase amount table,
wherein the invalidation ratio increase amount table includes one or more invalidation ratio increase amounts of the memory region calculated respectively at one or more update time points.

17. The memory system of claim 16, wherein the controller is further configured to delay a garbage collection operation on the memory region when an average of one or more invalidation ratio increase amounts of the memory region at the one or more update time points is greater than a delay threshold.

18. The memory system of claim 16, wherein the controller is further configured to advance a garbage collection operation on the memory region when an average of one or more invalidation ratio increase amounts of the memory region at the one or more update time points is less than an advancement threshold.

19. The memory system of claim 16, wherein the controller is further configured to advance a garbage collection operation on the memory region when an average of one or more invalidation ratio increase amounts of the memory region at the one or more update time points is less than an advancement threshold, and the invalidation ratio of the memory region at the current update time point is greater than a minimum threshold.

20. The memory system of claim 16, wherein the current update time point is when a predetermined number of memory regions become closed after the previous update time point.
